(19) United States
(12) Patent Application Publication
(10) Pub. No.: US 2013/0179357 A1
(43) Pub. Date: Jul. 11, 2013

(54) PROPERTY APPRAISAL EVALUATION USING TRAFFIC DATA

(71) Applicants: Nathan Pieter Den Herder, Falls Church, VA (US); Hamilton Fout, Rockville, MD (US); Steven Pierce, Annandale, VA (US); Eric Rosenblatt, Derwood, MD (US); John Treadwell, Washington, DC (US)

(72) Inventors: Nathan Pieter Den Herder, Falls Church, VA (US); Hamilton Fout, Rockville, MD (US); Steven Pierce, Annandale, VA (US); Eric Rosenblatt, Derwood, MD (US); John Treadwell, Washington, DC (US)

(73) Assignee: Fannie Mae, Washington, DC (US)

(21) Appl. No.: 13/346,153

(22) Filed: Jan. 9, 2012

(51) Int. Cl. G06Q 50/16

(52) U.S. Cl. 705/306

(57) ABSTRACT

A valuation model accounts for traffic features associated with modeled properties, generates listings of model-chosen comparables, and evaluates property appraisals and appraisal-chosen comparables accordingly. In one embodiment, traffic features of homes are used in automated electronic appraising and in the electronic review of appraisals. It first uses GIS techniques to convert traffic features associated with a property into a numeric variable, allowing hedonic price models to measure the price impact of traffic features. This allows traffic features to be used in the automated selection of comparable properties and in the adjusting of comp prices in appraisals. It also allows automated review of appraisals to determine if they fairly accounted for the traffic dimension in the selection of comps and in making any price adjustments. In one example, the automatic valuation uses a regression that models the relationship between price and explanatory variables, with the explanatory variables including traffic feature variables.

### BACKGROUND OF THE INVENTION

1. Field of the Invention

This application relates generally to property valuation using an automated valuation model (AVM), more particularly to evaluating property appraisals using traffic data in conjunction with an AVM.

2. Description of the Related Art

Automated valuation models (AVM) have seen increasing use in the real estate market since the 1990s when they first entered wide use by institutional investors in the market. They are used to evaluate properties based upon objective characteristics which help reduce the time and money required to arrive at accurate pricing for those properties. The accuracy of the model is useful for those interested in prices of property, including realtors, private home owners, mortgage bankers, and secondary mortgage market participants.

The impact of the market value of a home may differ depending on the interested party. For a homeowner it affects their equity position in the home, whereas the secondary mortgage market is concerned with the risk of default or prepayment which is heavily correlated with changes in the value of the real property backing the mortgage debt.

Regardless, accuracy is important to parties interested in property valuation or in evaluating an appraisal of a subject property. One area where accuracy can be affected involves proximity of the subject property to specific traffic features. The level of proximity to a traffic feature (e.g., a highway or a congested traffic area) can have a very significant effect on valuation. Sometimes the effect is high while other time the effect is marginal. However, accounting for proximity to many of these features appropriately would be difficult in the AVM environment, due to the high volume of property data and the asymmetric nature of traffic features.

What is needed is improved modeling of property values, associating traffic features for properties to the valuation, as well as facilities for automatically assessing and evaluating appraisals using traffic feature data.

### SUMMARY OF THE INVENTION

A valuation model accounts for traffic features associated with modeled properties, generates listings of model-chosen comparables, and evaluates property appraisals and appraisal-chosen comparables accordingly.

In one embodiment, traffic features of homes are used in automated electronic appraising and in the electronic review of appraisals. It first uses GIS techniques to convert traffic features associated with a property into a numeric variable, allowing hedonic price models to measure the price impact of traffic features. This allows traffic features to be used in the automated selection of comparable properties and in the adjusting of comp prices in appraisals. It also allows automated review of appraisals to determine if they fairly accounted for the traffic dimension in the selection of comps and in making any price adjustments.

For example, the automatic valuation uses a regression that models the relationship between price and explanatory variables, with the explanatory variables including traffic feature variables. Adjustments and exclusions in evaluating comparables may also be made bases upon traffic feature characteristics. Thus, an appraisal may be evaluated by comparing comparables to those produced by an automated valuation model that implements traffic features, by making and reviewing adjustments and/or exclusions based upon traffic features, and by classifying properties according to traffic features to determine the appropriateness of the listed comparables.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are block diagrams illustrating examples of systems in which a comparable property modeling and mapping application operates.

FIG. 2 is a flow diagram illustrating an example of a process for modeling comparable properties.

FIG. 3 is a flow diagram illustrating an example of modeling and mapping comparable properties.

FIG. 4 is a flow diagram illustrating a process for determining proximity to a traffic flow feature.

FIG. 5 is a flow diagram illustrating a process for determining proximity to a traffic feature.

FIG. 6 is a flow diagram illustrating a process for determining marketability of a traffic feature.

FIG. 7 is a block diagram illustrating an example of a comparable property modeling application with traffic feature proximity determination.

FIGS. 8A-D are display diagrams illustrating examples of map images and corresponding property grid data.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

A valuation model as described herein accounts for traffic features associated with modeled properties, generates listings of model-chosen comparables, and evaluates property appraisals and appraisal-chosen comparables accordingly.

In one embodiment, traffic features of homes are used in automated electronic appraising and in the electronic review of appraisals. It first uses GIS techniques to convert traffic features associated with a property into a numeric variable, allowing hedonic price models to measure the price impact of traffic features. This allows traffic features to be used in the automated selection of comparable properties and in the adjusting of comp prices in appraisals. It also allows automated review of appraisals to determine if they fairly accounted for the traffic dimension in the selection of comps and in making any price adjustments.

For example, the automatic valuation uses a regression that models the relationship between price and explanatory variables, with the explanatory variables including traffic feature variables. Adjustments and exclusions in evaluating comparables may also be made bases upon traffic feature characteristics. Thus, an appraisal may be evaluated by comparing comparables to those produced by an automated valuation model that implements traffic features, by making and reviewing adjustments and/or exclusions based upon traffic features, and by classifying properties according to traffic features to determine the appropriateness of the listed comparables.

One embodiment of an AVM described herein incorporates traffic data from an outside source and attaches this traffic data to the appraisal data. The combined data is then used to perform a hedonic modeling, a comp modeling, and adjustment modeling to evaluate comparable properties in an appraisal. The combined data is also enriched with GIS data corresponding to traffic features and otherwise.

According to one aspect, the present invention models comparable properties and renders map images and associated information useful for analyzing comparable properties. Preferably, the valuation model identifies and accounts for the proximity of properties to specified traffic features. For example, the valuation model may automatically determine properties bordering a highway and provide adjustments accordingly.

In one embodiment, estimating property value includes accessing property data corresponding to a specified traffic feature and performing a regression based upon the property data. The regression models the relationship between price and explanatory variables, with the explanatory variables including proximity to the traffic feature(s).

A subject property is identified, and a set of value adjustments is automatically determined based upon differences in the explanatory variables between the subject property and each of a plurality of comparable properties, with the set of value adjustments including a determination of the proximity to the traffic feature(s) for the subject property and the plurality of comparable properties. A value for the subject property is then estimated based upon the set of value adjustments.

In one example, the proximity to certain type of traffic feature may determine the set of value adjustments for subject property and each of the plurality of comparable properties. The set of value adjustments includes determination as to the marketability of the traffic feature(s) for the subject property and the plurality of comparable properties. A value for the subject property is then estimated based upon the set of value adjustments which in turn is based on the marketability of the traffic feature(s).

In another example, only those properties bordering a traffic feature are considered to be sufficiently proximate to the traffic feature. In other examples, distance may be used as a metric for determining sufficient proximity to the traffic feature, potentially with further examination to identify bordering properties. Proximate properties may have an associated adjustment factor and bordering properties another adjustment factor.

In one example, the determination of proximity entails accessing map data that provides a layout for a certain traffic feature such as a highway, as well as for parcels corresponding to a subject property and comparable properties. Once the layout for the traffic feature is determined, candidate parcels for proximity (e.g., bordering) are identified based upon whether the layout of the traffic feature overlaps the parcels corresponding to the properties.

Border logic may be applied to identify property parcels bordering the traffic feature. This, for example, may entail examining line(s) extending between location(s) designated for the traffic feature and location(s) designated for the parcels of candidate comparable properties. For example, bordering may be found where no intervening non-excluded parcel is present along the line between the traffic feature and the parcel for the candidate comparable property. In a more specific example, bordering may be found where no intervening non-excluded parcel is present along a line between a centroid of the parcel of the candidate comparable property and a midpoint of lines constituting the layout for the traffic feature. Still further, bordering proximity may be found where no intervening non-excluded parcel is present along lines between mid-points of the sides of the parcel of the candidate comparable property and a midpoint of lines constituting the layout for the traffic feature.

The regression modeling may vary, but in one example the property data is accessed and a regression models the relationship between price and explanatory variables (including at least one explanatory variable for a traffic feature). For example, a hedonic regression is performed at a geographic level (e.g., county) sufficient to produce reliable results. A pool of comparables is identified, such as by initial exclusion rules based upon distance from and other factors in relation to a subject property. A set of adjustments for each comparable is determined using adjustment factors drawn from the regression analysis. The comparables may then be weighted and displayed.

Various types of explanatory variable scenarios for the traffic feature may also be implemented. In one example, the explanatory variable for proximity to the traffic feature is a categorical variable, with proximity determined only when the subject property borders the traffic feature. As another example, the explanatory variable for proximity to the traffic feature depends upon the physical distance between the subject property and the traffic feature. In yet another example, the explanatory variable for proximity to the traffic feature depends upon the marketability of the subject property and the traffic feature.

A map image is displayed to illustrate the geographic distribution of the subject property and the comparable properties. An associated grid details information about the subject and comparable properties. The grid can be sorted according to a variety of property and other characteristics, and operates in conjunction with the map image to ease review of the comparables and corresponding criteria. The map image may be variously scaled and updates to show the subject property and corresponding comparables in the viewed range, and interacts with the grid (e.g. cursor overlay on comparable property in the map image allows highlighting of additional data in the grid).

(i) Hedonic Equation

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. The explanatory variables are:

(1) Four continuous property characteristics:

(a) log of gross living area (GLA),

(b) log of Lot Size,

(c) log of Age, and

(d) Number of Bathrooms; and

(2) five fixed effect variables:

(a) location fixed effect (e.g., by Census Block Group (CBG));

(b) Time fixed effect (e.g., measured by 3-month periods (quarters) counting back from the estimation date);

(c) Foreclosure status fixed effect, which captures the maintenance condition and possible REO discount;

(d) a traffic feature proximity variable “PX” that identifies proximity to a particular traffic feature.

(e) a speed limit variable “SP” that identifies the speed limit of the road on which the property resides.

(f) a marketability variable “MRK”, which provides a location fixed effect correlating a geographical sub-area (e.g., CBG) to a traffic marketability variables, such as a traffic congestion value or an average commuting time within a geographic sub-area.

The last three variables, PX, SP and MRK, are a set of traffic feature variables.

The PX variable identifies proximity to a particular traffic feature. For example, a high speed highway, such as an interstate highway, may be a particular traffic feature. If the property borders or is sufficiently proximate to a particular traffic feature, it can have positive or negative connotations. In the example of the interstate highway, being too close is considered a negative connotation. The PX variable is implemented in the regression to capture and correlate the price contribution, negative or positive, for the proximity to particular traffic feature. Where there are multiple traffic features, multiple PX variables may be used. Alternative, logic may be applied to determine the PX variable value based upon the presence or absence of a number of proximate particular geographical features. Proximity may be determined based upon distance, wherein properties within a certain distance of the particular traffic feature are considered to possess the characteristic of being proximate to the particular traffic feature. Alternatively, in a stricter modeling, the property would need to actually border the particular traffic feature to be considered as possessing the particular traffic feature.

The second traffic feature variable, SP, is a variable that identifies the speed limit of the road on which the property actually resides. If there are multiple roads bordering the parcel for the property, either an averaging of the speed limits or logic (e.g., determining the road corresponding to the front-facing side of the property) may be applied to determine the appropriate associated SP value for the property. The variable may variously correlate price to the variable. For example, a property located on a high speed limit road is likely going to have a negative connotation as compared to properties embedded within the same subdivision on lower speed limit roads.

To evaluate and assign the appropriate SP value for a given property, the following categorization and corresponding bucketing may be employed:

SP₄: property located on low speed limit, low traffic road, and is not close to a highway;

SP₃: either elevated speed limit and/or traffic, and is not close to a highway;

SP₂: low speed limit, low traffic, and is close to a highway;

SP₁: either elevated speed limit and/or traffic, and is close to a highway.

In one example, 25 mph may be used as a cutoff for determining whether the road is low speed limit or not, and closeness to the highway is determined at a 500 ft threshold. Though the aforementioned bucketing involves only four categories, additional categories may be added to accurately evaluate the correct SP value for a property.

A third example of a traffic feature variable is MRK, or marketability. This variable correlates the property to a corresponding traffic marketability condition. For example, a given geographical area may be broken down into numerous sub-areas (e.g., by CBG delineation). Each sub-area may have a corresponding traffic marketability condition, such as average commute time. Note, as an alternative to commute time, the MRK variable can classified by road type (highway, embedded development road, cul-de-sac). The regression will then use the MRK variable to model the relationship between price and the MRK value for properties within respective sub-areas based on the traffic marketability condition.

Specifically, if one of the defined subset of areas has an average commute of certain time of 50 minutes and another defined subset of areas has an average commute of a certain time of 20 minutes, the defined area that has a lower commute time will be given a desirable value while the defined area with a higher commute will be given a undesirable value.

As another example, the MRK variable may be bucketed according to average commute time to corresponding city center in 15 minute increments. For instance, an area or zone that has an average commute of 15 minutes may be in a first category of MRK value MRK₁, a property located in a 30 minute average commute time may be in a second category of MRK value of MRK₂ and so on.

With these explanatory variables, the example equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH + {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}} {FCL}_{k} + {\sum }_{m = 1}^{{N}_{PX}} {PX}_{m} + {\sum }_{m = 1}^{{N}_{MRK}} {MRK}_{m} + {\sum }_{m = 1}^{{N}_{SP}} {SP}_{m} + ɛ \qquad ( Eq . 1 )$$

The above equation is offered as an example, and as noted, there may be departures. For example, although CBG is used as the location fixed effect, other examples may include Census Tract or other units of geographic area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

(ii) Exclusion Rules

Comparable selection rules are then used to narrow the pool of comps to exclude the properties which are determined to be insufficiently similar to the subject.

A comparable property should be located in a relative vicinity of the subject and should be sold relatively recently; it should also be of similar size and age and sit on a commensurate parcel of land. The “N” comparables that pass through the exclusion rules are used for further analysis and value prediction.

For example, the following rules may be used to exclude comparables pursuant to narrowing the pool:

(1) Neighborhood: comps must be located in the Census Tract of the subject and its immediate neighboring tracts;

(2) Time: comps must be sales within twelve months of the effective date of appraisal or sale;

(3) GLA must be within a defined range, for example:

$$\frac{2}{3} \leq \frac{{GLA}_{S}}{{GLA}_{C}} \leq \frac{3}{2}$$

(4) Age similarity may be determined according to the following Table 1:

TABLE 1

| | | | | | | | |
|---|---|---|---|---|---|---|---|
| Subject Age | 0-2 | 3-5 | 6-10 | 11-20 | 21-40 | 41-65 | 65+ |
| Acceptable Comp Age | 0-5 | 0-10 | 2-20 | 5-40 | 11-65 | 15-80 | 45+ |

(5) Lot size similarity may be determined according to the following Table 2:

TABLE 2

| | | | | | | |
|---|---|---|---|---|---|---|
| Subject | <2000 | sqft | 2000-4000 | sqft | 4000 sqft-3 acres | >3 |
| Lot | | | | | | acres |
| size | | | | | | |
| Accept- able Comp Lot | 1-4000 | sqft | 1-8000 | sqft | $\frac{2}{5} \leq \frac{{LOT}_{S}}{{LOT}_{C}} \leq \frac{5}{2}$ | >1 acre |

(6) Traffic class. Properties are excluded based upon one or more of the above-described traffic feature variables, or combinations thereof. For example, according to the MRK variable, exclusion may be based upon presence of the comparable within the same MRK zone as the subject property, or at least within the same or an adjacent MRK zone. Similarly, exclusion may be made based upon the PX or SP variables, again with only comparable properties belonging to the same or sufficiently related buckets being appropriate for inclusion, and others excluded.

These exclusion rules are provided by way of example. There may be a set of exclusion rules that add variables, that omit one or more the described variables, or that use different thresholds or ranges.

Additionally, in addition to evaluation based upon the AVM modeling and ranking, appraiser-chosen comparables may be evaluated and scored based upon whether they satisfy the exclusion rules, with exceptionally poor scoring being determined where there are significant departures from the subject property. (e.g., multiple MRK zones removed from subject property).

(iii) Adjustment of Comps

Given the pool of comps selected by the model, the sale price of each comp may then be adjusted to reflect the difference between a given comp and the subject in each of the characteristics used in the hedonic price equation.

For example, individual adjustments are given by the following set of equations (2):

A_{gla}=exp└(ln(GLA_{S})−ln(GLA_{C}))·β_{gla}┘;

Aₗₒₜ=exp[(ln(LOT_{S})−ln(LOT_{C}))·βₗₒₜ];

A_{age}=exp└(ln(AGE_{S})−ln(AGE_{C}))·β_{age}┘;

A_{bath}=exp└(BATH_{S}−BATH_{C})·α_{age}┘;

A_{loc}=exp[LOC_{S}−LOC_{C}];

Aₜᵢₘₑ=exp[TIME_{S}−TIME_{C}];

A_{fcl}=exp[FCL_{S}−FCL_{C}];

Aₚₓ=exp[PX_{S}−PX_{C}]; and

Aₘᵣₖ=exp[MRK_{S}−MRK_{C}].

Aₛₚ=exp[SP_{S}−SP_{C}]. (Eq. 2)

where coefficients βgla, βlot, βage, βbath, LOC, TIME, FCL, PX, MRK, SP are obtained from the hedonic price equation described above. Hence, the adjusted price of the comparable sales is summarized as:

$${p}_{C}^{adj} = {p}_{C} \cdot {\prod }_{i ∈ \{ gla , lot , age , bath , loc , time , fcl , px , mrk , sp \}}^{ } {A}_{i} = {p}_{C} \cdot {A}_{TOTAL} \qquad ( Eq . 3 )$$

Similar to the exclusions, comparable properties can be independently evaluated by reviewing the adjustment made by an appraiser against the adjustment that the model would apply for the same adjustment factor.

(iv) Weighting of Comps and Value Prediction

Because of unknown neighborhood boundaries and potentially missing data, the pool of comparables will likely include more than are necessary for the best value prediction in most markets. The adjustments described above can be quite large given the differences between the subject property and comparable properties. Accordingly, rank ordering and weighting are also useful for the purpose of value prediction.

The economic distance D_{eco} between the subject property and a given comp may be describe as a function of the differences between them as measured in dollar value for a variety of characteristics, according to the adjustment factors described above.

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , loc , time , fcl , px , mrk , sp \}}^{ } {( {A}_{i} - 1 )}^{2}} \qquad ( Eq . 4 )$$

The comps are then weighted. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {D}_{SC}^{time}} \qquad ( Eq . 5 )$$

where D_{geo} is a measure of a geographic distance between the comp and the subject, defined as a piece-wise function:

$${D}_{SC}^{eco} = \{ \begin{matrix}0.1 & if & {d}_{SC} < 0.1 mi \\ {d}_{SC} & if & 0.1 mi \leq {d}_{SC} \leq 1.0 mi \\ 1.0 + \sqrt{{d}_{SC} - 1.0} & if & {d}_{SC} > 1.0 mi ,\end{matrix} \qquad ( Eq . 6 )$$

and Dₜᵢₘₑ is a down-weighting age of comp sale factor

$${D}_{SC}^{time} = \{ \begin{matrix}1.00 & if & ( 0 , 90 ] days \\ 1.25 & if & ( 90 , 180 ] days \\ 2.00 & if & ( 180 , 270 ] days \\ 2.50 & if & ( 270 , 365 ] days .\end{matrix} \qquad ( Eq . 7 )$$

Comps with higher weight receive higher rank and consequently contribute more value to the final prediction, since the predicted value of the subject property based on comparable sales model is given by the weighted average of the adjusted price of all comps:

$$\hat{p} s = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 8 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

According to another aspect, mapping and analytical tools that implement the comparable model are provided. Mapping features allow the subject property and comparable properties to be concurrently displayed. Additionally, a table or grid of data for the subject properties is concurrently displayable so that the list of comparables can be manipulated, with the indicators on the map image updating accordingly.

For example, mapping features include the capability to display the boundaries of census units, school attendance zones, neighborhoods, as well as statistical information such as median home values, average home age, etc. The mapping features also accommodate the illustration of traffic features of interest along comparable properties, offering visual depiction of properties that border the feature.

The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales.

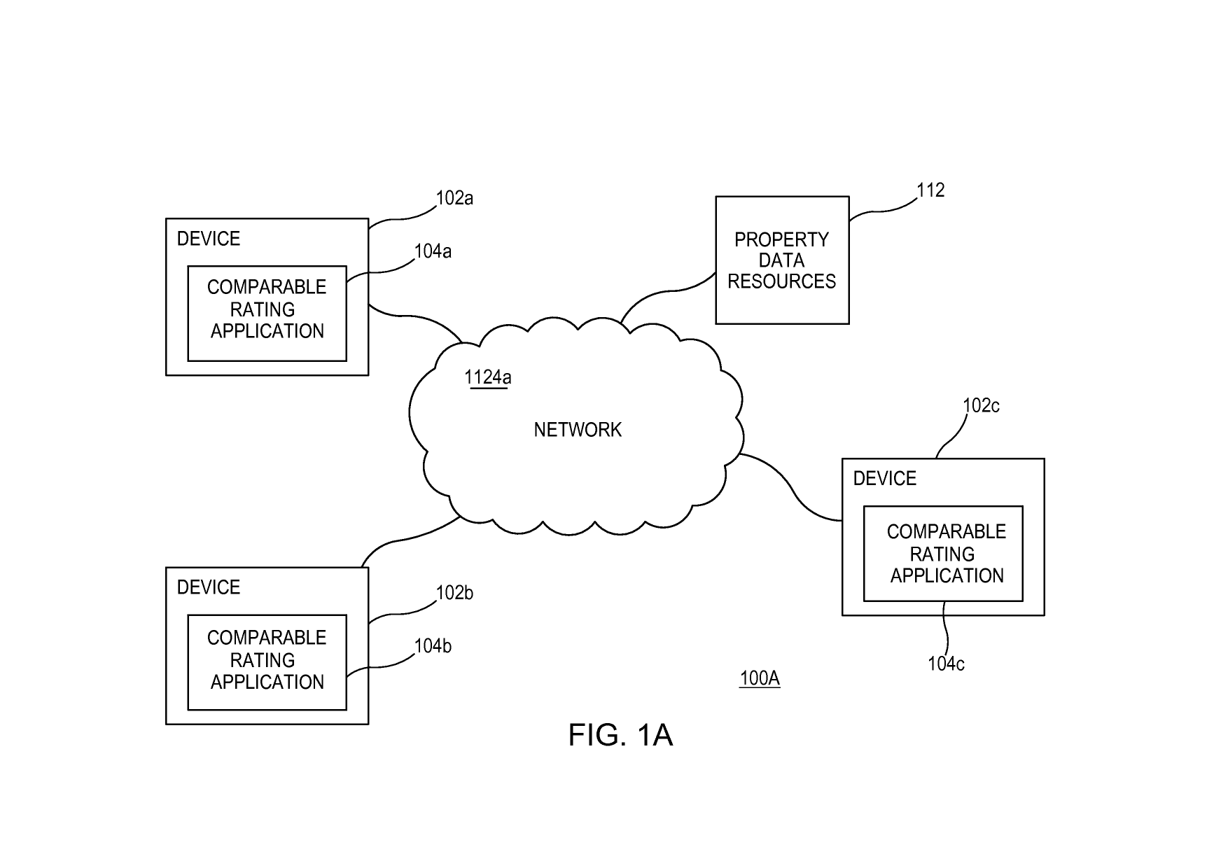

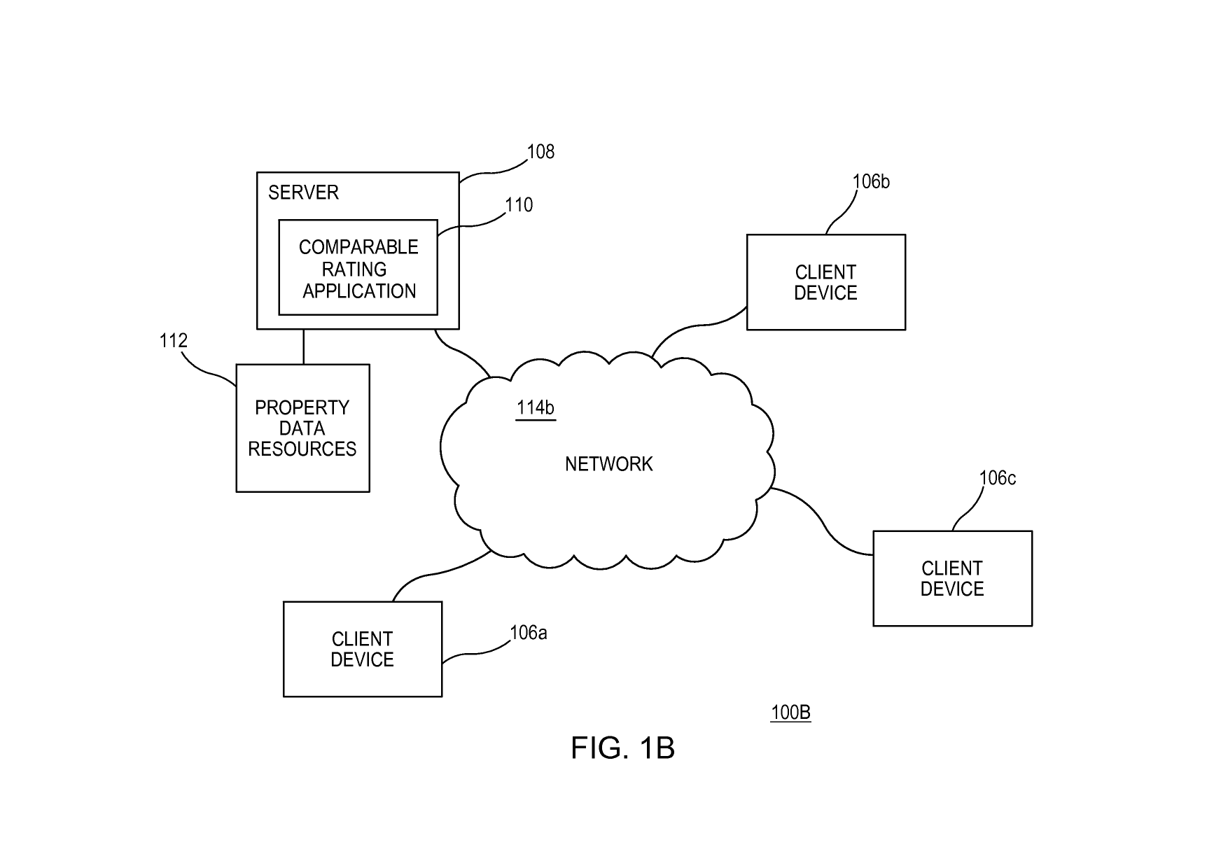

FIGS. 1A-B are block diagrams illustrating examples of systems 100A-B in which a comparable property modeling application operates.

FIG. 1A illustrates several user devices 102a-c each having a comparable property modeling application 104a-c.

The user devices 102a-d are preferably computer devices, which may be referred to as workstations, although they may be any conventional computing device. The network over which the devices 102a-d may communicate may also implement any conventional technology, including but not limited to cellular, WiFi, WLAN, LAN, or combinations thereof.

In one embodiment, the comparable property modeling application 104a-c is an application that is installed on the user device 102a-c. For example, the user device 102a-c may be configured with a web browser application, with the application configured to run in the context of the functionality of the browser application. This configuration may also implement a network architecture wherein the comparable property modeling applications 104a-c provide, share and rely upon the comparable property modeling application 104a-c functionality.

As an alternative, as illustrated in FIG. 1B, the computing devices 106a-c may respectively access a server 108, such as through conventional web browsing, with the server 108 providing the comparable property modeling application 110 for access by the client computing devices 106a-c. As another alternative, the functionality may be divided between the computing devices and server. Finally, of course, a single computing device may be independent configured to include the comparable property modeling application.

As illustrated in FIGS. 1A-B, property data resources 110 are typically accessed externally for use by the comparable property modeling application, since the amount of property data is rather voluminous, and since the application is configured to allow access to any county or local area in a very large geographic area (e.g., for an entire country such as the United States). Additionally, the property data resources 110 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property modeling application accesses and retrieves the property data from these resources in support of the modeling of comparable properties as well as the rendering of map images of subject properties and corresponding comparable properties, and the display of supportive data (e.g., in grid form) in association with the map images.

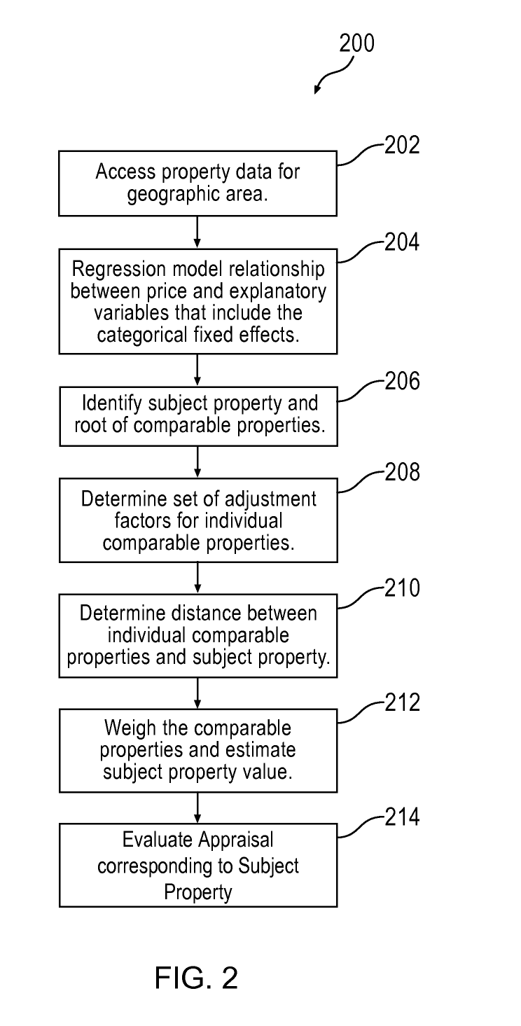

FIG. 2 is a flow diagram illustrating an example of a process 200 for modeling comparable properties, which may be performed by the comparable property modeling application.

As has been described, the application accesses 202 property data. This is preferably tailored at a geographic area of interest in which a subject property is located (e.g., county). A regression 204 modeling the relationship between price and explanatory variables is then performed on the accessed data. Although various alternatives may be applied, a preferred regression is that described above, wherein the explanatory variables are the four property characteristics (GLA, lot size, age, number of bathrooms) as well as the categorical fixed effects (border feature status, PX, SP, MRK, location, time, foreclosure status).

A subject property within the county is identified 206 as is a pool of comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of comparable properties for each particular subject property.

The pool of comparable properties may be initially defined using exclusion rules. This limits the unwieldy number of comparables that would likely be present if the entire county level data were included in the modeling of the comparables.

Although a variety of exclusion rules can be used, in one example they may include one or more of the following: (1) limiting the comparable properties to those within the same census tract as the subject property (or, the same census tract and any adjacent tracts); (2) including only comparable properties where the transaction (e.g., sale) is within 12 months of the effective date of the appraisal or transaction (sale); (3) requiring GLA to be within a range including that of the subject property (e.g., +/−50% of the GLA of the subject property); (4) requiring the age of the comparable properties to be within an assigned range as determined by the age of the subject property (e.g., as described previously); and/or (5) requiring the lot size for the comparable properties to be within an assigned range as determined by the lot size of the subject property (e.g., as described previously).

Once the pool is so-limited, a set of adjustment factors is determined 208 for each remaining comparable property. The adjustment factors may be a numerical representation of the price contribution of each of the explanatory variables, as determined from the difference between the subject property and the comparable property for a given explanatory variable. An example of the equations for determining these individual adjustments has been provided above.

Once these adjustment factors have been determined 208, the “economic distance” between the subject property and respective individual comparable properties is determined 210. The economic distance may be constituted as a quantified value representative of the estimated price difference between the two properties as determined from the set of adjustment factors for each of the explanatory variables.

Following determining of the economic distance, the comparable properties may be weighted 212 in support of generating a ranking of the comparable properties according to the model. One example of a weighting entails a function inversely proportional to the economic distance, geographic distance and age of transaction (typically sale) of the comparable property from the subject property.

The weights may further be used to calculate an estimated price of the subject property comprising a weighted average of the adjusted price of all of the comparable properties.

Once the model has performed the regression, adjustments and weighting of comparables, the information is conveyed to the user in the form of grid and map image displays to allow convenient and comprehensive review and analysis of the set of comparables.

Finally, an appraisal of the subject property is evaluated 214 accordingly. The appraisal contains a listing of comparable properties that is compared to the comparable properties as determined by the model. In addition to reviewing the listing based upon the modeling (which implements the traffic feature variable(s) in the regression), further assessments may be made based upon a comparison of the traffic class that is determined for the comparable properties in the appraisal as compared to the traffic class of the subject property (and/or the traffic class of the closest model-chosen comparables). Still further, if adjustments are made based upon traffic features in the appraisal, these adjustments can be compared to the adjustments that the model indicates as appropriate for the geographical area and traffic features pertinent to the subject property. These and various other appraisal review processes may be provided.

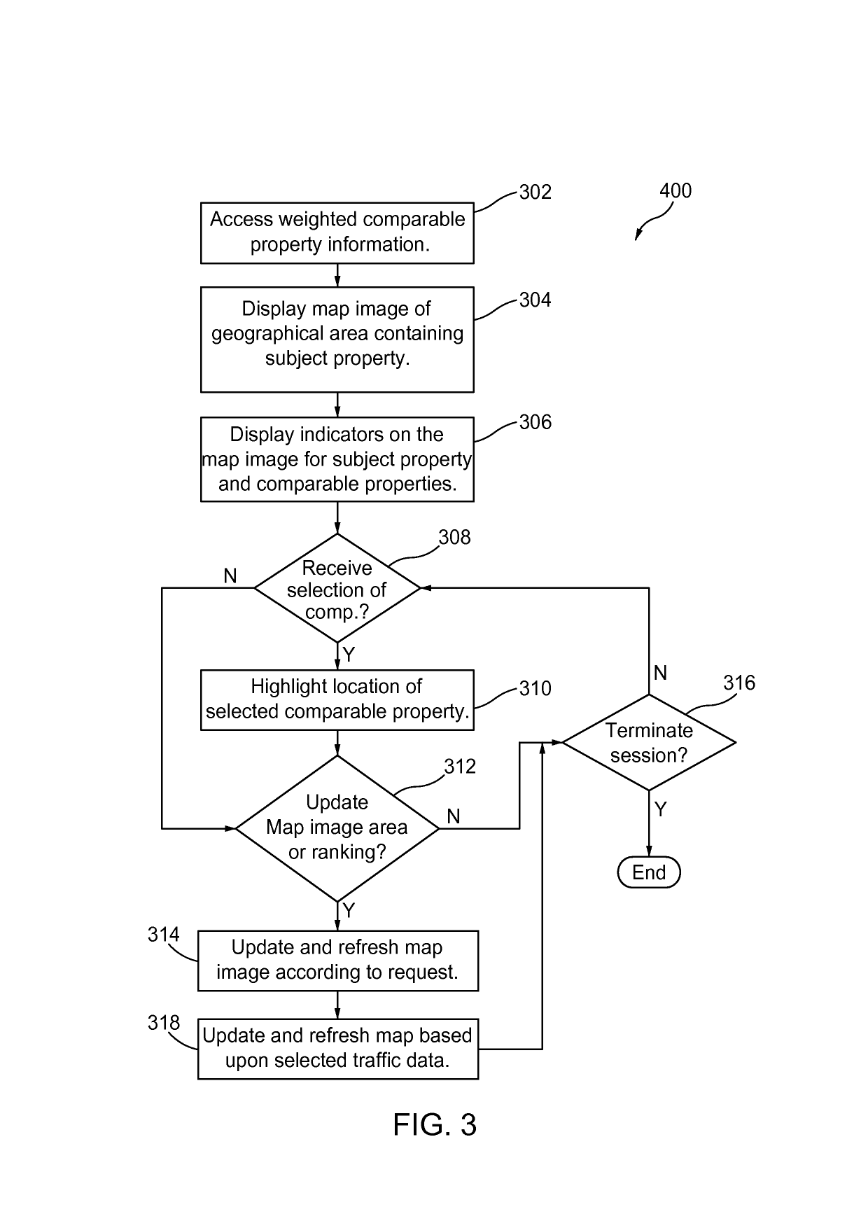

FIG. 3 is a flow diagram illustrating an example of a process 300 for modeling and mapping comparable properties with initial access 302 of the weighted comparable property information. This may be as described above, such as wherein the comparable properties are weighted according to the economic distance, geographic distance and age of transaction information.

The process also includes display 304 of a map image of a geographic area containing the subject property. The map image information may be acquired from conventional mapping resources, including but not limited to Google maps and the like. Additionally, conventional techniques may be used to depict subject and comparable properties on the map image, such as through determination of the coordinates from address information.

The map imagery may be various updated to provide user-desired views, including zooming in and out to provide more narrow or broad perspectives of the depictions of the comparable and subject properties. Additionally, the map imagery is updated to reflect the current display of various traffic features. In one example, a highway may be depicted as a traffic feature in the map image, along with parcels corresponding to properties. Although one embodiment describes the determination of bordering status for a highway, embodiments of the invention are not so-limited. For example, the model may implement determinations whether a property borders other traffic features including major roads, mass transit conduits, low speed limit roads, high traffic congestion areas, commercial properties/zones, cul-de-sacs, power plants, railroads, garbage dumps, etc. The model may also implement determinations whether a property borders higher marketable traffic features such as transit oriented developments, market based car-pooling roads, HOV lanes, local express lanes, toll roads, high congestions/commuting areas, etc.

The property data includes information as to the location of the properties, and either this native data may be used, or it may be supplemented, to acquire that exact location of the subject property and potential comparable properties on the map image. This allows the map image to be populated with indicators that display 306 the location of the subject property and the comparable properties in visually distinguishable fashion on the map image. The number of comparable properties that are shown can be predetermined or may be configurable based upon user preferences. The number of comparable properties that are shown may also update depending upon the level of granularity of the mage image. That is, when the user updates 312 the map image such as by zooming out to encompass a wider geographic area, when the map image updates 314 additional comparable properties may be rendered in addition to those rendered at a more local range. In addition to zooming out to include a wider geographical area, the map can be updated based upon the manipulation and selection of traffic data 318. For instance, a model can be run and then updated based on a selection of a certain traffic feature and then be ranked and displayed according to that selected criteria.

Additionally, model-chosen comparables may be compared to comparables listed in an appraisal report, so as to assess how appropriate the appraisal comparables are as compared to those in the model. Along with the mapping feature, this provides a visual presentation of the proximity of both the model and appraisal-chosen comparables to traffic features, offering further assessment of the appraisal.

The user may also prompt a particular comparable property to be highlighted 310, such as by cursor rollover or selection of an entry for the comparable property in a listing. When the application receives 308 an indication that a property has been selected, it is highlighted in the map. Conversely, the user may also select the indicator for a property on the map image, which causes display of the details corresponding to the selected property.

Updating of the map image, highlighting of selected properties, and other review of the property data continues until termination (316) of the current session.

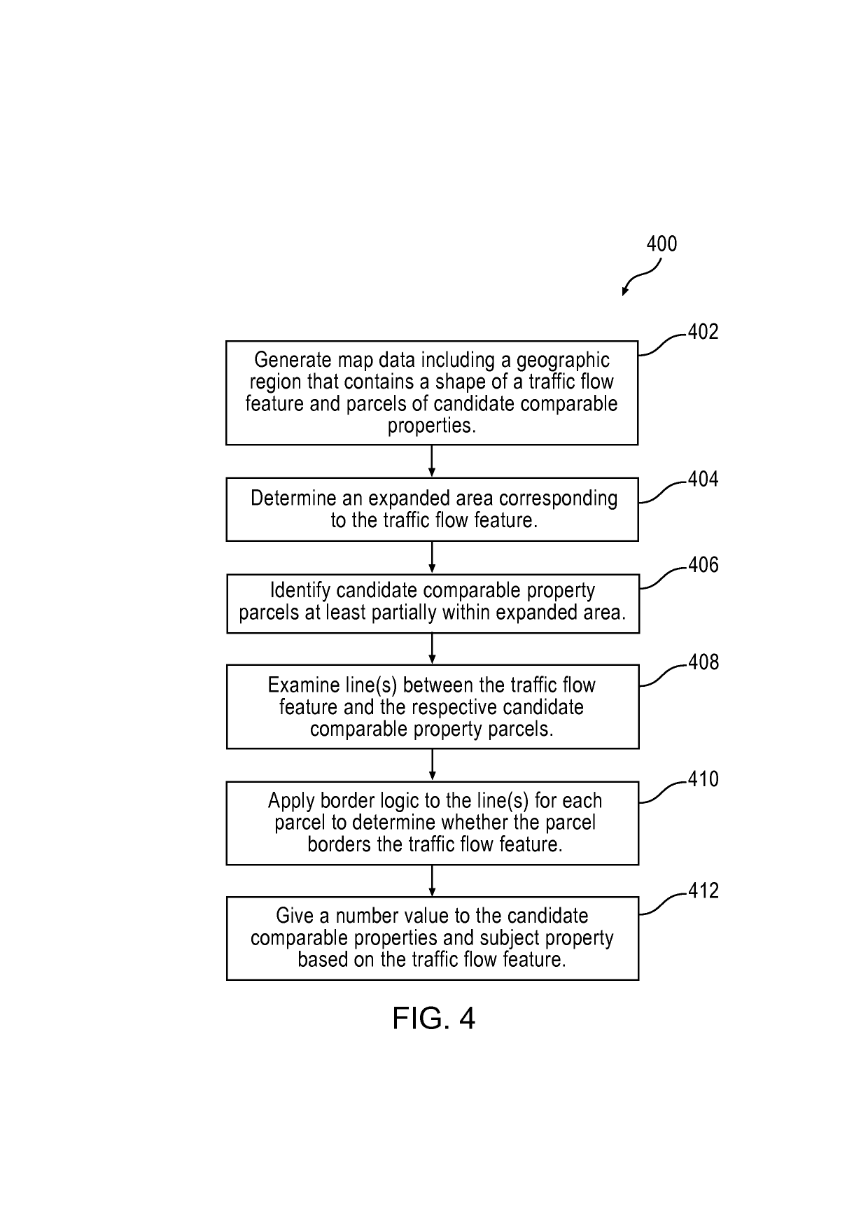

FIG. 4 is a flow diagram illustrating a process 400 for determining proximity to a traffic flow feature. In this example, the traffic flow feature may be a highway, which may be constituted as a shape on a map image and corresponding map data.

Specifically, a given geographic region (MSA, county, zip, Census tract/group, etc.) and a traffic flow feature of interest are generated 402 as a shape on a map, as described above. Parcel data for candidate comparable properties is also populated on the generated 402 map data.

An initial processing is made to determine the set of candidate comparable properties that will be considered for proximity to the traffic flow feature of interest. This may be performed by determining 404 an expanded area corresponding to the traffic flow feature of interest, followed by identification 406 of candidate comparable properties at least partially within the expanded area.

For example, for a given traffic region, the shape of the region (“Shape A”) and the shape of the feature of interest (“Shape B”) are saved. The shape of the region, Shape A, is then expanded outward a given distance. The expanded portion of Shape A forms a new shape (“Shape C”). Where Shape C shares the same space as Shape B is saved as a new shape (“Shape D”), which is the overlap between the expanded parts of the region and the feature's shape. Shape D is then expanded outward onto the original region shape, Shape A, to create Shape E. Parcels of land on Shape A that fall within Shape E are included as candidate comparable property parcels subject to further analysis as to whether they are proximate to the traffic flow feature of interest.

Once the candidate comparable property parcels are identified, they are further examined to determine proximity to the traffic flow feature of interest. In one embodiment, bordering proximity is sought and determined. Bordering proximity means that the parcel is determined to be adjacent to the traffic feature of interest, without intervening property parcels. Bordering proximity may be determined by examining lines extending between one or more locations designated for the candidate comparable property parcel and a location for the traffic feature of interest (408). Then, border logic is applied to the lines corresponding to each candidate comparable property parcel in order to determine whether the parcel borders the traffic feature (410).

Generally, the border logic examines whether there are intervening parcels between the parcel for the candidate comparable property and the traffic feature of interest. Parcels greater than a specified size are excluded from the count of interactions to avoid counting areas which do not represent properties or are in some way part of the feature. Thus, “non-excluded” parcels are deemed property parcels.

For instance, lines are directly extended from the centroid of the parcel and the midpoints of all the individual lines which make up the parcel's shape to a location designated for the identified traffic feature. In one example, the closest point of the feature is used as the point of reference for the feature. Alternatives may apply depending upon the type of feature and the decision logic. The number of interactions the line has before interacting with the shape of the traffic feature is tracked.

Various logic may be applied to conclude the bordering condition. For example, if both the line drawn from the centroid and at least one of the lines drawn from the midpoints of the sides of the parcel do not intersect with non-excluded parcels, then the parcel is determined as bordering the traffic feature.

Once all of the candidate comparable properties are examined to determine whether they are proximate to the traffic flow feature of interest, the valuation model may be updated accordingly in order to account for adjustment factors based upon proximity to the traffic feature as described above and below.

After determining that the candidate comparable properties are proximate to a particular traffic flow feature of interest, the traffic flow feature of interest is given a numerical value 412. This value is dependant on the whether the traffic flow feature is desirable or undesirable in nature. For instance, properties that are close to a high traffic flow feature, such as a high speed highway, would be considered undesirable and would be given a low value. On the other hand, properties that are close to a cul-de-sac would be given a higher value since living near a cul-de-sac generally denotes a positive correlation. The specific value that will be given to the candidate comparable properties and subject properties will be based upon relative desirability of the traffic flow feature and will be given a numerical value in the range of 0 to 5, where 0 represents an undesirable traffic flow feature and 5 denotes a desirable traffic flow feature.

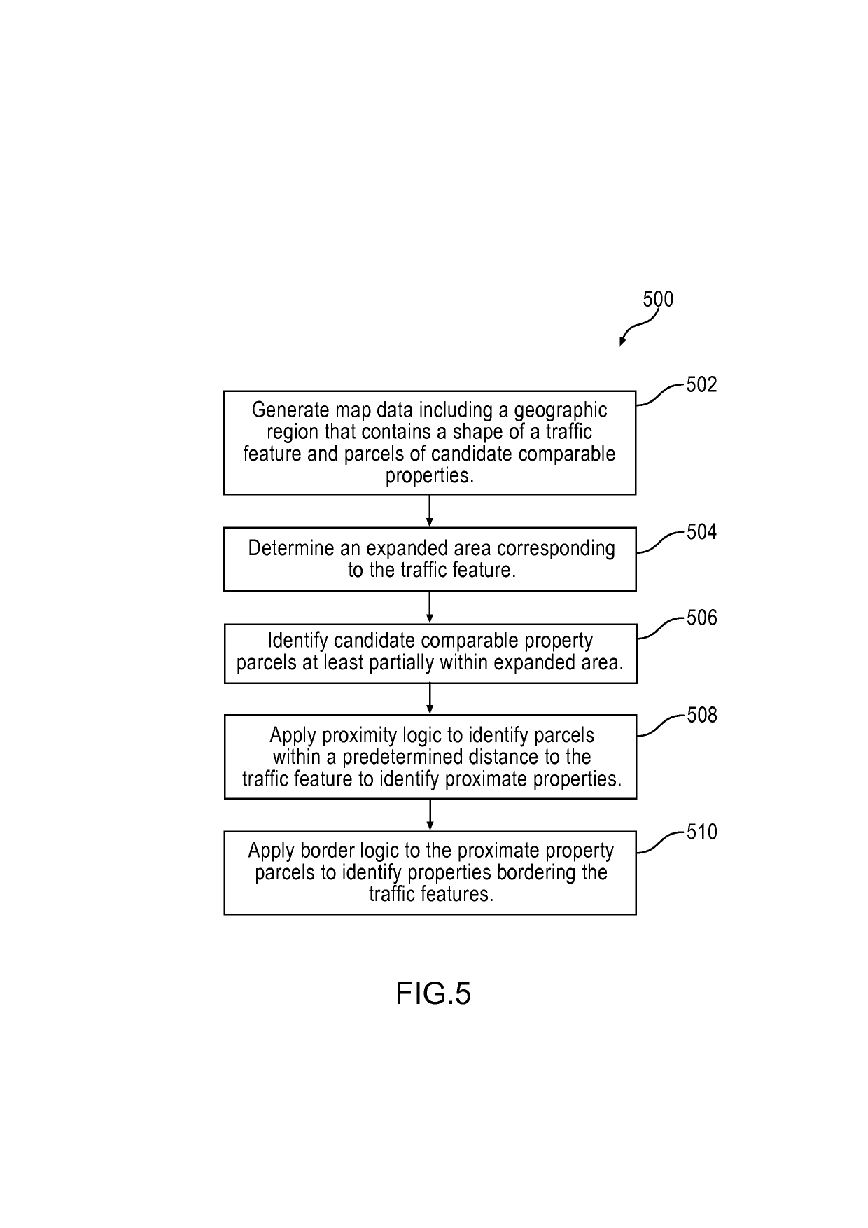

FIG. 5 is a flow diagram illustrating a process 500 for determining whether property parcels are located on specified traffic feature, specifically a high speed limit road. In one embodiment, the explanatory variable used in the regression described above implements a binary determination whether the property borders a high speed limit road. In other words, once the demarcation point is determined for a high speed limit road, “SP” can either be “0,” indicating a high speed limit road or “1,” indicating a low speed limit road. Although this aspect is likely more pertinent to the SP variable, the PX variable may be binary if desired as well. For example, only properties that actually border a high speed limit road are considered to be high speed limit road bordering properties. In other embodiments, a first degree of proximity connotes a first value adjustment, and a second degree of proximity connotes a second value adjustment. The second value adjustment has some import, but may differ from the first value adjustment. As an example, properties that border a high speed limit road are characterized as a first level, and properties that border the high speed limit road bordering properties are characterized at a second level. In this sense, the determination may be according to one of three conditions ((1) properties bordering a high speed limit road; (2) properties bordering high speed limit road bordering properties (i.e., next-closest properties to the high speed limit road), and (3) no bordering (i.e., houses neither under (1) or (2)). Additionally, alternative embodiments may implement distance based determinations as part of the regression.

The process 500 similarly initiates by determining the set of candidate comparable properties that will be considered for proximity to the traffic feature of interest (in this case property parcels that are located on a low/high speed limit road) by generating 502 the relevant map data, determining 504 an expanded area corresponding to the traffic feature of interest and then identifying 506 parcels at least partially within the expanded shape of the area of overlap for further consideration whether they should be considered to have proximity to the traffic feature of interest.

Proximity logic is then applied 508 to determine whether the parcels border the traffic feature of interest (that is, located next to a low/high speed limit road). The physical distance between a location designated for the parcel (e.g., centroid) and a location designated for the traffic feature of interest (e.g., closest point on feature perimeter) may be examined to determine whether it is within a threshold distance deemed as providing sufficient bordering. For example, for a low-speed limit road bordering property, a parcel determined to be within 0.15 miles of the traffic feature of interest (the low speed road) may be determined as bordering to the traffic feature of interest.

Following application of the proximity logic, the set of candidate comparable properties within sufficient proximity may be associated with an adjustment factor for such proximity. However, a subset of the proximate properties may merit a different adjustment, because the subset of the proximate properties borders the traffic feature of interest. Accordingly, border logic is applied 510 in order to determine which of the parcels also borders the feature. The border logic may be as described previously regarding FIG. 4.

It should be understood that road speed limit or proximity to a highway are not the only traffic features of interest. As one alternative, a mass transit conduit such a metro stop may be a traffic feature of interest. Properties close to the mass transit conduit may merit an adjustment factor that differs from properties not close to the mass transit conduit. As such, the proximity and border logic may involve different adjustments. For example, while proximity to a mass transit conduit may connote a certain adjustment, it may be undesirable to actually border the mass transit conduit. Adjustment factors for these and other examples of traffic features may be determined and applied by the valuation model described herein, with adjustments to include additional explanatory variables where appropriate.

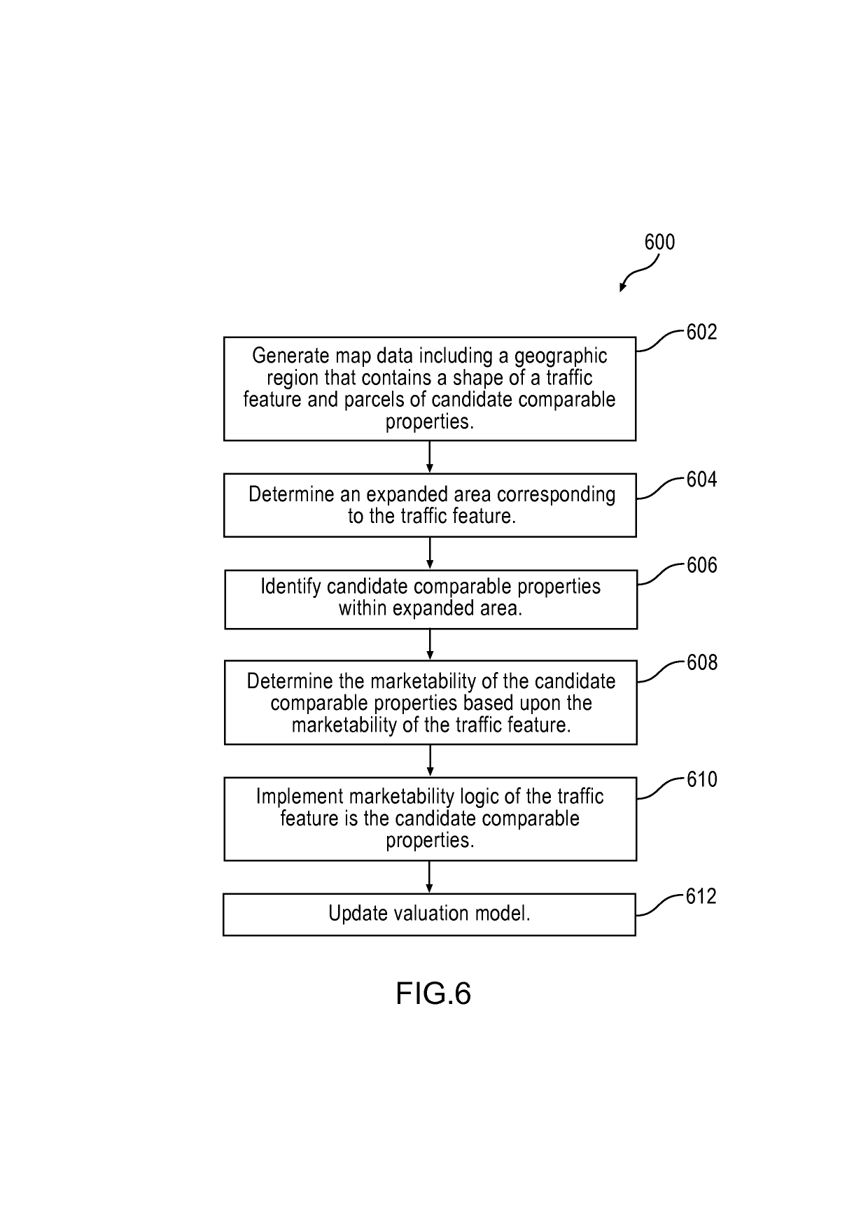

FIG. 6 is a flow diagram illustrating a process 600 for determining the marketability or salability of a traffic feature. In this example, the traffic feature may be a mass transit conduit, which may be constituted as a shape on a map image and corresponding map data.

Specifically, a given geographic region (MSA, county, zip, Census tract/group, etc.) and a traffic feature of interest are generated 602 as a shape on a map, such as through a MRK valuation as described above. Parcel data for candidate comparable properties is also populated on the generated 602 map data.

An initial processing is made to determine the set of candidate comparable properties that will be considered for proximity to the traffic feature of interest. This may be performed by determining 604 an expanded area corresponding to the traffic feature of interest, followed by identification 606 of candidate comparable properties at least partially within the expanded area.

Once the candidate comparable property parcels are identified, they are further examined to determine the marketability of the traffic feature of interest 608. In one embodiment, the explanatory variable used in the regression described above implements a marketability gradation logic to determine the marketability of a candidate property that borders a traffic feature of interest. For instance, a gradation level from 1-5 will help determine the marketability or salability of the traffic feature of interest, where 1 denotes a low marketability traffic feature and 5 denotes a high marketability traffic feature. Thereafter, a candidate property is given MRK gradation value based upon the marketability of the traffic feature of interest.

Generally, the marketability logic examines whether candidate properties located near a traffic feature of interest have the same marketability or salability. Certain properties near a highly desirable traffic feature, such as a low speed limit road, may be given a value of 4 while properties near a low desirable traffic feature, such as a high speed limit road, may be given a 2.

Once all of the candidate comparable properties are examined to determine the marketability of a traffic feature, the valuation model may also be updated accordingly in order to account for adjustment factors based upon proximity to the traffic feature as described above.

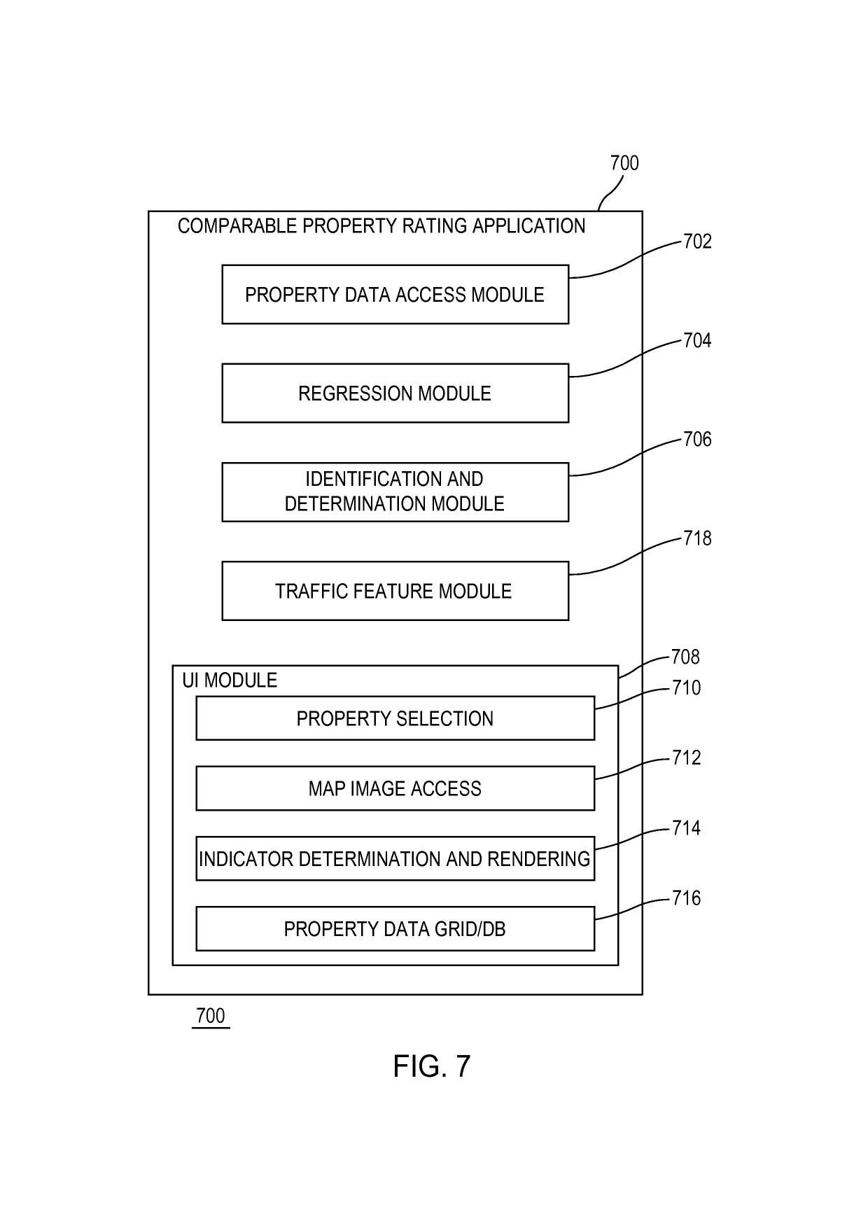

FIG. 7 is a block diagram illustrating an example of a comparable property modeling application 700. The application 700 preferably comprises program code that is stored on a computer readable medium (e.g., compact disk, hard disk, etc.) and that is executable by a processor to perform operations in support of modeling and mapping comparable properties.

According to one aspect, the application includes program code executable to perform operations of accessing property data corresponding to a geographic area, and performing a regression based upon the property data, with the regression modeling the relationship between price and explanatory variables. A subject property and a plurality of comparable properties are identified, followed by determining a set of value adjustments for each of the plurality of comparable properties based upon differences in the explanatory variables between the subject property and each of the plurality of comparable properties. An economic distance between the subject property and each of the comparable properties is determined, with the economic distance constituted as a quantified value determined from the set of value adjustments for each respective comparable property. Once the properties are identified and the adjustments are determined, there is a weighting of the plurality of comparable properties based upon the appropriateness of each of the plurality of comparable properties as comparables for the subject property, the weighting being based upon one or more of the economic distance from the subject property, geographic distance from the subject property, and age of transaction.

The application 700 also includes program code for displaying a map image corresponding to the geographic area, and displaying indicators on the map image indicative of the subject property and at least one of the plurality of comparable properties, as well as ranking the plurality of comparable properties based upon the weighting, and displaying a text listing of the plurality of comparable properties according to the ranking. Finally, the application is configured to receive input indicating selection of comparable properties and to update the map images and indicators as described.

The comparable property modeling application 700 is preferably provided as software, but may alternatively be provided as hardware or firmware, or any combination of software, hardware and/or firmware. The application 700 is configured to provide the comparable property modeling and mapping functionality described herein. Although one modular breakdown of the application 700 is offered, it should be understood that the same functionality may be provided using fewer, greater or differently named modules.

The example of the comparable property modeling application 700 of FIG. 7 includes a property data access module 702, regression module 704, adjustment and weighting module 706, traffic feature module 718, and UI module 708, with the UI module 708 further including a property selection module 710, map image access module 712, indicator determining and rendering module 714 and property data grid/DB module 716.

The property data access module 702 includes program code for carrying access and management of the property data, whether from internal or external resources. The regression module 704 includes program code for carrying out the regression upon the accessed property data, according to the regression algorithm described above, and produces corresponding results such as the determination of regression coefficients and other data at the country (or other) level as appropriate for a subject property. The regression module 704 may implement any conventional code for carrying out the regression given the described explanatory variables and property data.

The adjustment and weighting module 706 is configured to apply the exclusion rules, and to calculate the set of adjustment factors for the individual comparables, the economic distance, and the weighting of the comparables.

The traffic feature module 718 manages the identification of traffic features, processing of rendered shapes for the traffic features, processing of the marketability or salability of the traffic features, and application of logic and corresponding determinations whether properties are proximate to the traffic features, such as through the functionality described in connection with FIGS. 4-5 above.

The UI module 708 manages the display and receipt of information to provide the described functionality. It includes a property selection module 710, to manage the interfaces and input used to identify one or more subject properties, from which a determination of the corresponding geographic area is determined in support of defining the scope of the regression and other functionality. The map image access module 712 accesses mapping functions and manages the depiction of the map images as well as the indicators of the subject property and the comparable properties. The indicator determination and rendering module 714 is configured to manage which indicators should be indicated on the map image depending upon the current map image, the weighted ranking of the comparables and predetermined settings or user input. The property data grid/DB 716 manages the data set corresponding to a current session, including the subject property and pool of comparable properties. It is configured as a database that allows the property data for the properties to be displayed in a tabular or grid format, with various sorting according to the property characteristics, economic distance, geographic distance, time, etc.

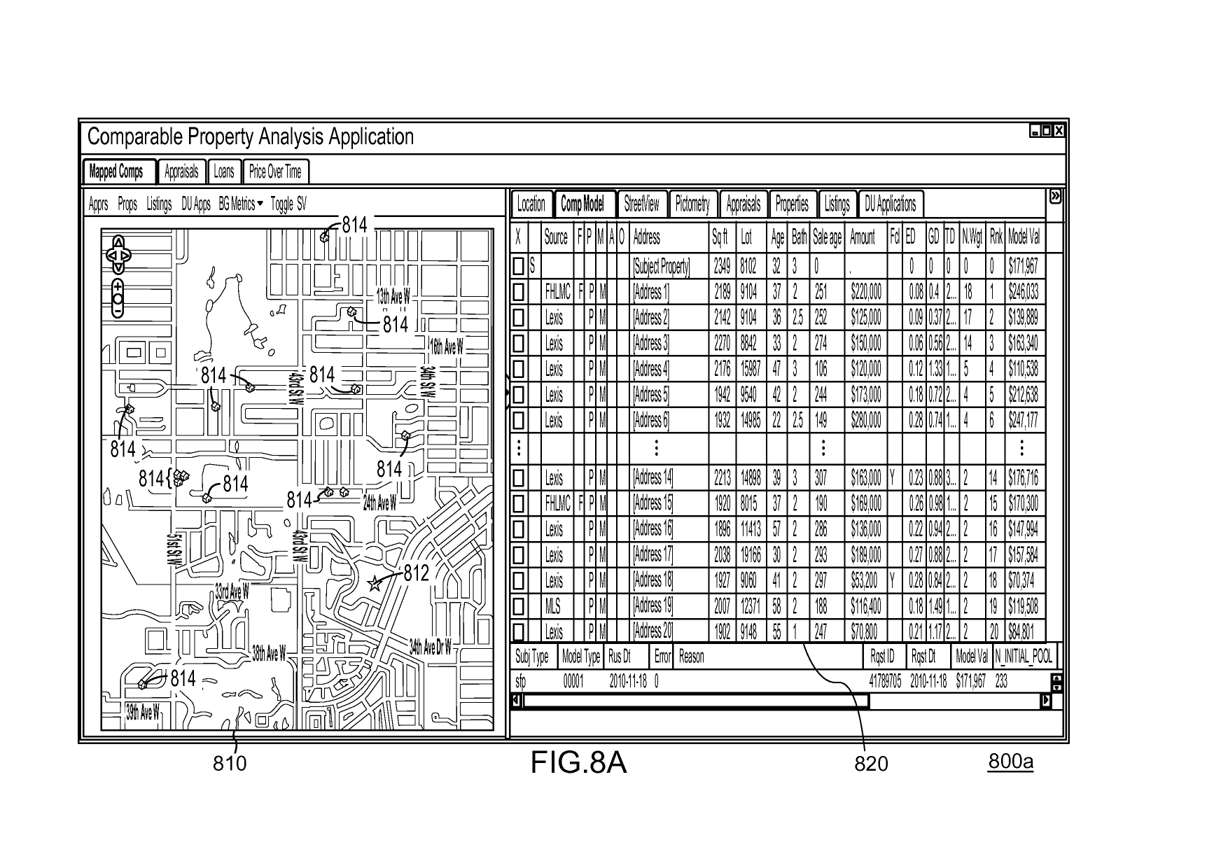

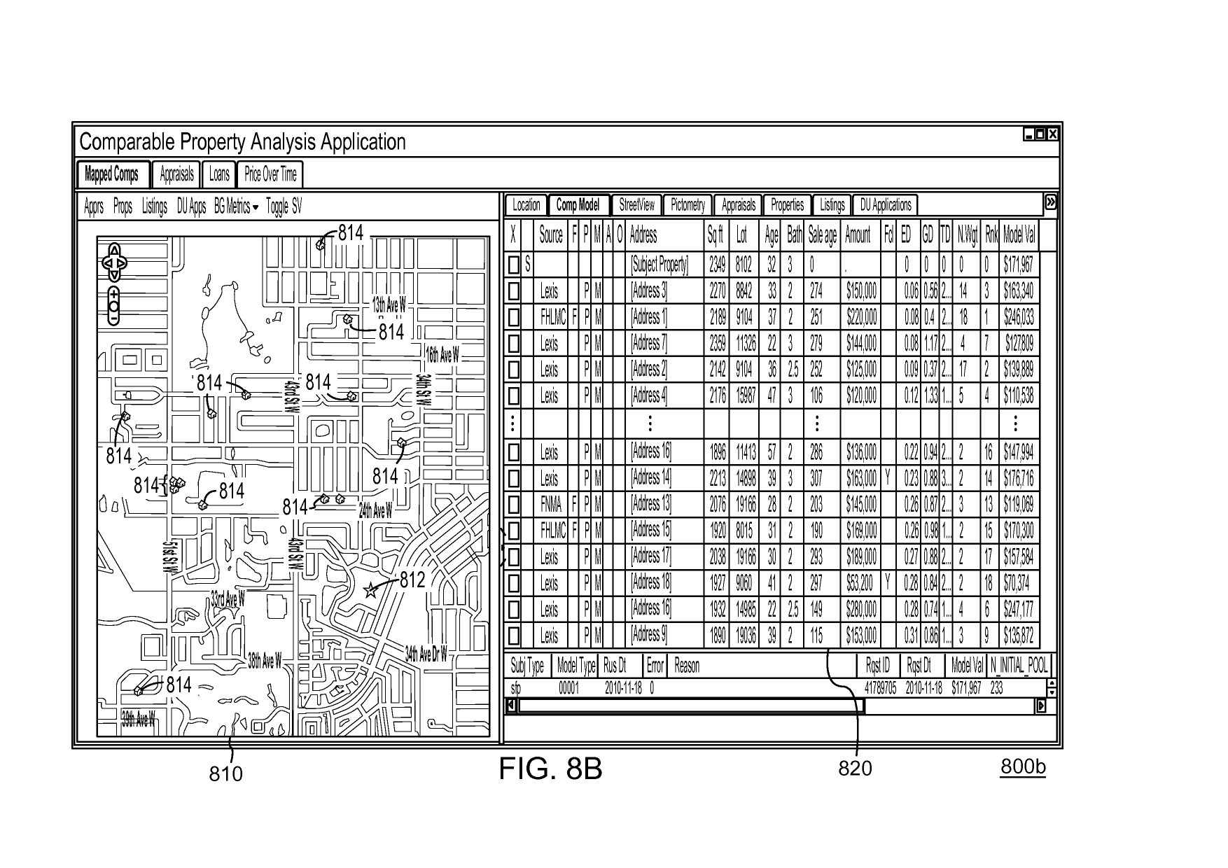

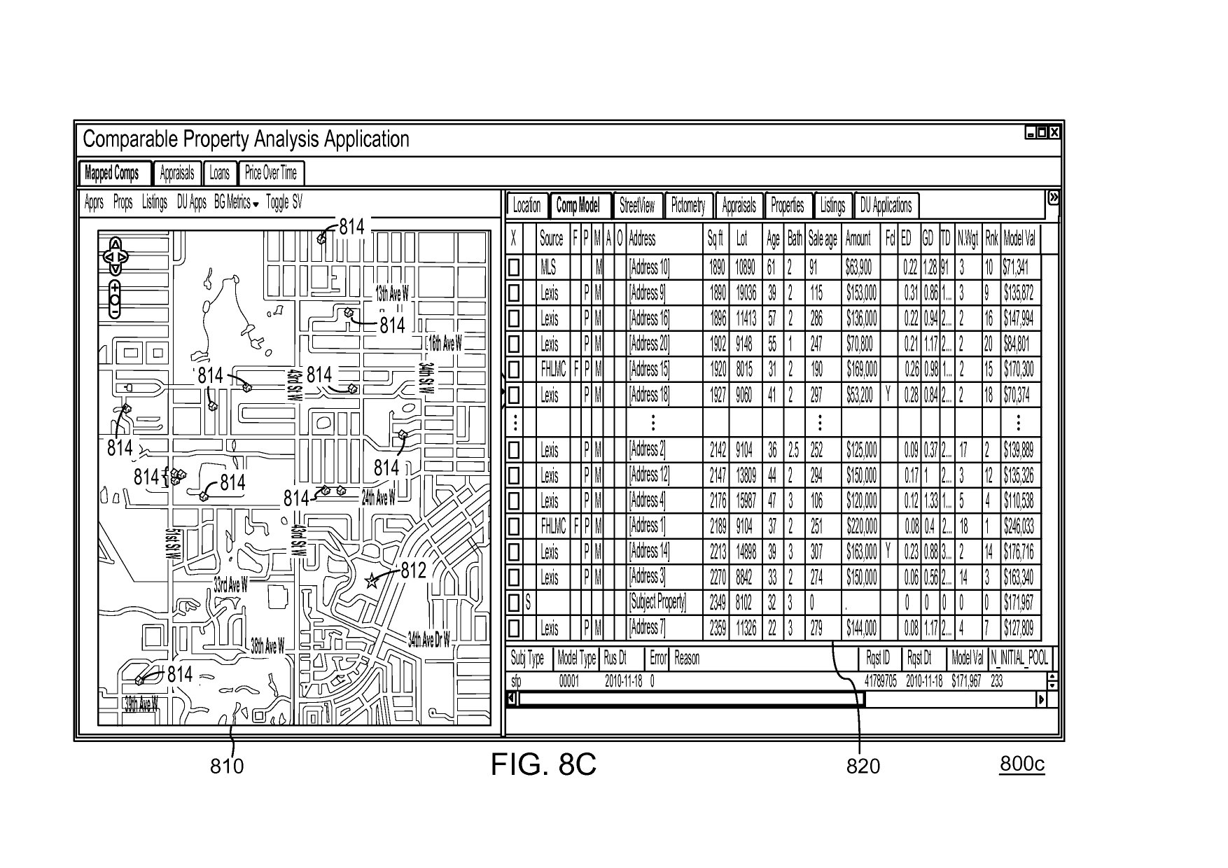

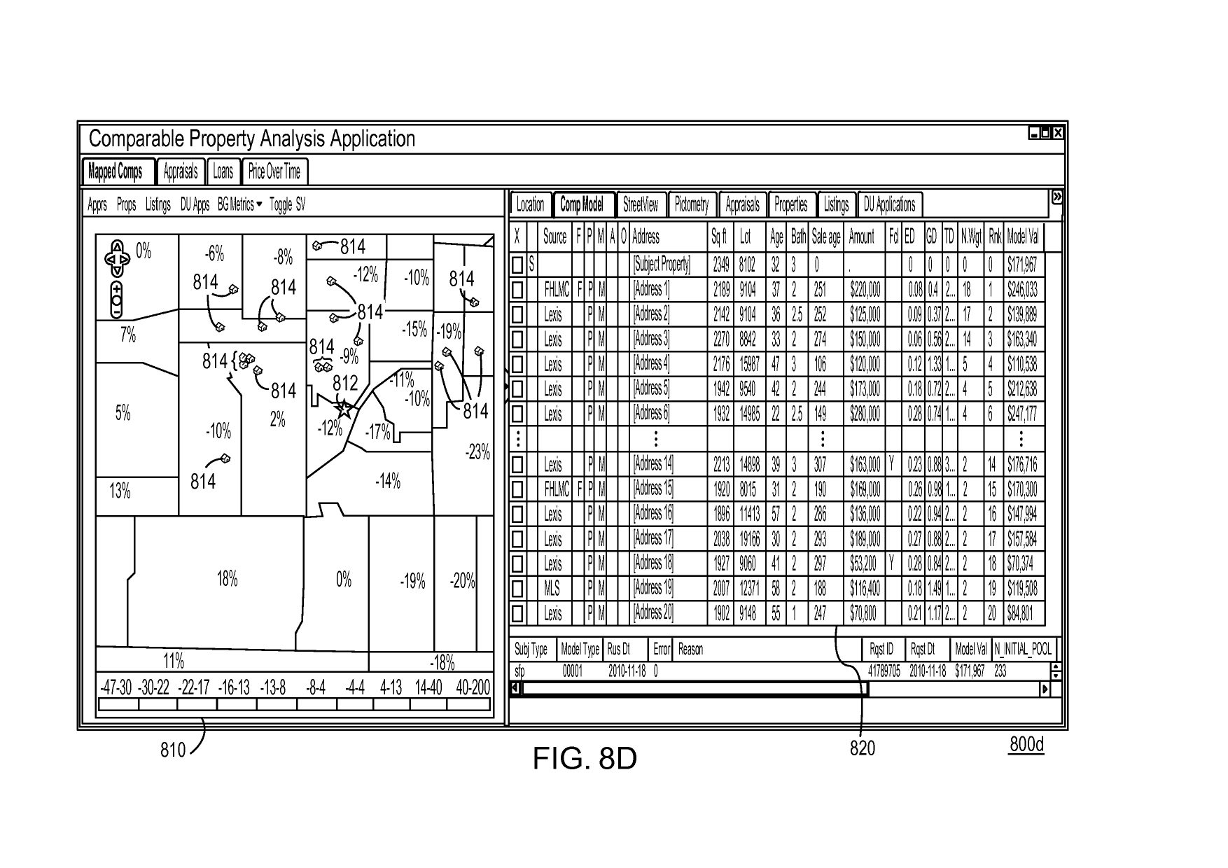

FIGS. 8A-D are display diagrams illustrating examples of map images and corresponding property grid data that can be generated by the comparable property modeling application.

For example, FIG. 8A illustrates an example of a display screen 800a that concurrently displays a map image 810 and a corresponding property data grid 820. This screen may be displayed following selection of a subject property by a user followed by prompting a running of the comparable property model, which identifies the comparable properties, determines adjustment factors, determines economic distance and weights the comparable properties, such as described above.

The map image 810 depicts a region that can be manipulated to show a larger or smaller area, or moved to shift the center of the map image, in convention fashion. This allows the user to review the location of the subject property 812 and corresponding comps 814 at any desired level of granularity. This map image 810 may be separately viewed on a full screen, or may be illustrated alongside the property data grid 820 as shown.

The property grid data 820 contains a listing of details about the subject property and the comparable properties, as well as various information fields. The fields include an identifier field (e.g., “S” indicates the subject property), the source of data for the property (“Source”), the address of the property (“Address”), the square footage (“Sq Ft”), the lot size (“Lot”), the age of the property (“Age”), the number of bathrooms (“Bath”), the age of the prior sale (“Sale Age”), the prior sale amount (“Amount”), the foreclosure status (“FCL”, y/n), border feature status (“SP”, not shown), PX feature status (“PX”, not shown), MRK feature status (“MRK”, not shown), the economic distance (“ED”), geographic distance (“GD”) and time distance (“TD”, e.g., as measured in days) factors as described above, the weight (“N. Wgt”), the ranking by weight (“Rnk”), and the valuation as determined from the comparable sales model (“Model Val”).

The map image 810 allows the user to place a cursor over any of the illustrated properties to prompt highlighting of information for that property and other information. Additionally, the listing of comparables in the property grid data 820 can be updated according to any of the listed columns. For example, the display screen 800b in FIG. 8B illustrates the listing sorted by the economic distance, and the display screen 800c in FIG. 8C illustrates sorting according to the square footage of the properties. The grid data can be variously sorted to allow the user to review how the subject property compares to the listed comparable properties.

According to another aspect, the map image 810 can be divided into regions to help further assess the location of the subject property and corresponding properties. FIG. 8D illustrates the map image 810 updated to indicate several CBG regions 816 in the map image 810, illustrated as separated by dark lines. Additionally, within each CBG 816 the map image is updated to indicate a relative adjustment as compared to a country average for each CBG. This helps the user to further assess how the subject property relates to the comparable properties, with the CBG acting as a proxy for neighborhood. In an embodiment employing traffic feature analysis, the CBG may correspond to different marketability regions as described above. This helps the user to immediately visually observe the locations of the various properties with respect to such regions.

The user may variously update the map image and manipulate the property data grid in order to review and assess and subject property and the corresponding comparable properties in a fashion that is both flexible and comprehensive.

Thus embodiments of the present invention produce and provide methods and apparatus for property valuation using traffic data. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for evaluating comparable properties in an automated valuation model, the method comprising:
accessing property data corresponding to a geographical area;
performing a regression based upon the property data, the regression modeling the relationship between price and explanatory variables, the explanatory variables including a set of one or more traffic variables;
identifying a subject property; and
evaluating comparable properties corresponding to the subject priority based upon results of the regression.

2. The method of claim 1, wherein the set of traffic variables includes a traffic feature variable, the traffic feature variable identifying a traffic feature, and the regression models the relationship between price and proximity to the traffic feature using the traffic feature variable.

3. The method of claim 2, further comprising:
accessing map data including a shape for the traffic feature and parcels of candidate comparable properties;
determining an expanded area corresponding to the traffic feature; and
determining the proximity to the traffic feature includes determining whether the expanded area overlaps a parcel of a candidate comparable property.

4. The method of claim 3, wherein determining the proximity to the traffic feature further includes examining a line extending between a location designated for the traffic feature and a location designated for the parcel of the candidate comparable property.

5. The method of claim 4, wherein determining the proximity to the traffic feature includes determining a bordering proximity, and wherein determining the bordering proximity includes determining whether an intervening non-excluded parcel is present along the line between the traffic feature and the parcel of the candidate comparable property.

6. The method of claim 1, wherein the set of traffic variables includes a speed limit variable, the speed limit variable identifying a speed limit of a road on which the property resides.

7. The method of claim 1, wherein the set of traffic variables includes a marketability variable, the marketability variable identifying a traffic marketability factor.

8. The method of claim 7, further comprising:
determining subset geographical areas; and
associating a value for the marketability variable for properties within each of the subset geographical areas.

9. The method of claim 8, wherein the marketability variable is average commute time respectively within each of the subset geographical areas.

10. A computer program product for evaluating comparable properties in an automated valuation model, the computer program product comprising program code stored on a non-transitory computer readable medium, the program code being executable to perform operations comprising:
accessing property data corresponding to a geographical area;
performing a regression based upon the property data, the regression modeling the relationship between price and explanatory variables, the explanatory variables including a set of one or more traffic variables;
identifying a subject property; and
evaluating comparable properties corresponding to the subject priority based upon results of the regression.

11. The computer program product of claim 10, wherein the set of traffic variables includes a traffic feature variable, the traffic feature variable identifying a traffic feature, and the regression models the relationship between price and proximity to the traffic feature using the traffic feature variable.

12. The computer program product of claim 11, wherein the operations further comprise:
accessing map data including a shape for the traffic feature and parcels of candidate comparable properties;
determining an expanded area corresponding to the traffic feature; and
determining the proximity to the traffic feature includes determining whether the expanded area overlaps a parcel of a candidate comparable property.

13. The computer program product of claim 12, wherein determining the proximity to the traffic feature further includes examining a line extending between a location designated for the traffic feature and a location designated for the parcel of the candidate comparable property.

14. The computer program product of claim 13, wherein determining the proximity to the traffic feature includes determining a bordering proximity, and wherein determining the bordering proximity includes determining whether an intervening non-excluded parcel is present along the line between the traffic feature and the parcel of the candidate comparable property.

15. The computer program product of claim 10, wherein the set of traffic variables includes a speed limit variable, the speed limit variable identifying a speed limit of a road on which the property resides.

16. The computer program product of claim 10, wherein the set of traffic variables includes a marketability variable, the marketability variable identifying a traffic marketability factor.

17. The computer program product of claim 16, wherein the operations further comprise:
determining subset geographical areas; and
associating a value for the marketability variable for properties within each of the subset geographical areas.

18. The computer program product of claim 17, wherein the marketability variable is average commute time respectively within each of the subset geographical areas.

19. A system for evaluating comparable properties in an automated valuation model, the system comprising:
a processor; and
a memory, the memory storing program code executable by the processor to perform operations comprising:
accessing property data corresponding to a geographical area,
performing a regression based upon the property data, the regression modeling the relationship between price and explanatory variables, the explanatory variables including a set of one or more traffic variables,
identifying a subject property, and
evaluating comparable properties corresponding to the subject priority based upon results of the regression.
